(19) United States
(12) Patent Application Publication
(10) Pub. No.: US 2021/0096281 A1
(43) Pub. Date: Apr. 1, 2021

(54) HARD COATING FILM AND WINDOW AND IMAGE DISPLAY DEVICE USING SAME

(71) Applicant: DONGWOO FINE-CHEM CO., LTD., Jeollabuk-do 54631 (KR)

(72) Inventors: Seung-Hee Kim, Gyeonggi-do 16941 (KR); Geo-San Lim, Seoul 04595 (KR); Min-Kyung Kang, Gyeonggi-do 18482 (KR); Hye-Lin Kim, Busan 47536 (KR)

(21) Appl. No.: 17/036,143

(22) Filed: Sep. 29, 2020

(30) Foreign Application Priority Data
Oct. 1, 2019 (KR) 10-2019-0121800

(51) Int. Cl. G02B 1/14; G02B 1/04

(52) U.S. Cl. CPC G02B 1/14; G06F 1/1607; G02B 1/04

(57) ABSTRACT

The present invention relates to a hard coating film including a substrate and a hard coating layer provided on at least one surface of the substrate, the hard coating layer including a cured product of a hard coating composition containing a fluorine-based UV-curable-functional-group-containing compound, a light-transmissive resin, and a fluorine-based solvent, and the fluorine-based solvent is contained in an amount of 0.1 to 40 wt % based on a total of 100 wt % of the hard coating composition, and to a window and an image display device using the same.

### CROSS REFERENCE TO RELATED APPLICATION

This application claims the benefit of Korean Patent Application No. KR 10-2019-0121800, filed on Oct. 1, 2019, which is hereby incorporated by reference in its entirety into this application.

### BACKGROUND OF THE INVENTION

### 1. Technical Field

The present invention relates to a hard coating film and to a window and an image display device including the same.

### 2. Description of the Related Art

A flexible display is a display that is bendable or foldable, and various technologies and patents related thereto have been proposed. When the display is designed to have a foldable form, it may be used as a tablet when unfolded and a smartphone when folded, so displays having different sizes may be used in a single product. In addition, in the case of larger-sized devices such as tablets and TVs, rather than small-sized smartphones, convenience may be doubled if they may be folded and carried.

In a general display, a cover window made of glass is provided on the outermost side to protect the display. However, glass cannot be applied to foldable displays, and a hard coating film having high hardness and wear resistance is used in place of glass.

In recent years, hard coating films are required to exhibit, as important performance characteristics thereof, antifouling properties related to resistance to marking by fingerprints, markers, etc. and/or ease of removal thereof, in addition to hard coating properties.

Korean Patent Application Publication No. 10-2016-0083293 discloses a coating composition having superior slippage properties and antifouling properties. This coating composition includes (i) a fluorocarbon polymer represented by Chemical Formula 1, (ii) at least one slip agent selected from the group consisting of a polyether-modified polydimethylsiloxane-based compound, a fluorine-modified polyacrylate-based compound, and a perfluoropolyether (PFPE)-based compound, and (iii) a solvent.

Also, Korean Patent Application Publication No. 10-2005-0010064 discloses an object on which a composite hard coating layer is provided and a method of forming a composite hard coating layer. Specifically, an object on which a composite hard coating layer is formed is disclosed, the composite hard coating layer including a hard coating layer provided on the surface of the object and an antifouling surface layer provided on the surface of the hard coating layer. The hard coating layer of the above document is formed of a cured product of a hard coating composition including an active-energy-ray-curable composition, the antifouling surface layer is formed of a cured product of a surface material including a multifunctional (meth)acrylate compound containing fluorine and a monofunctional (meth)acrylate compound containing fluorine, and the antifouling surface layer is fixed to the hard coating layer.

However, in the conventional documents, when the antifouling layer in a thin film form is applied onto glass, it cannot be applied to a flexible device, and when applied to a polymer substrate film, scratch resistance and pencil hardness cannot be ensured, so a separate hard coating layer or the like is additionally required. Moreover, the case in which the hard coating layer and the antifouling layer are individually applied onto the polymer substrate film is problematic because the process becomes complicated and there is a price increase due to a decrease in yield and an increase in processing costs.

Therefore, it is necessary to develop a hard coating film that may be applied to a flexible display and may exhibit both wear resistance and antifouling performance.

### CITATION LIST

### Patent Literature

Korean Patent Application Publication No. 10-2016-0083293 (Jul. 12, 2016)

Korean Patent Application Publication No. 10-2005-0010064 (Jan. 26, 2005)

### SUMMARY OF THE INVENTION

The present invention is intended to provide a hard coating film that may exhibit both wear resistance and antifouling performance.

In addition, the present invention is intended to provide a hard coating film having high hardness.

In addition, the present invention is intended to provide a window including the hard coating film as described above.

In addition, the present invention is intended to provide an image display device including the window as described above.

The present invention provides a hard coating film including a substrate and a hard coating layer provided on at least one surface of the substrate, in which the hard coating layer includes a cured product of a hard coating composition containing a fluorine-based UV-curable-functional-group-containing compound, a light-transmissive resin, and a fluorine-based solvent, and the fluorine-based solvent is contained in an amount of 0.1 to 40 wt % based on a total of 100 wt % of the hard coating composition.

In addition, the present invention provides a window including the hard coating film as described above.

In addition, the present invention provides an image display device including the window as described above and a display panel, and further including a touch sensor and a polarizing plate between the window and the display panel.

According to the present invention, a hard coating film has high hardness and can exhibit both wear resistance and antifouling performance, so it is applicable to windows not only for image display devices but also for flexible display devices.

### BRIEF DESCRIPTION OF DRAWINGS

FIG. 1A shows the configuration of an image display device according to an embodiment of the present invention having a display panel (200), a lower adhesive layer or a pressure-sensitive adhesive layer (502), a touch sensor (300), a polarizing plate (400), an upper adhesive layer or an upper pressure-sensitive adhesive layer (501), and a window (100) that may be sequentially laminated.

FIG. 1B shows the configuration of an image display device according to an embodiment of the present invention having a display panel (200), a polarizing plate (400), a lower adhesive layer or a lower pressure-sensitive adhesive layer (502), a touch sensor (300), an upper adhesive layer or an upper pressure-sensitive adhesive layer (501), and a window (100) that may be sequentially laminated.

FIG. 1C shows the configuration of an image display device according to an embodiment of the present invention having a display panel (200), a touch sensor (300), a polarizing plate (400), an adhesive layer or a pressure-sensitive adhesive layer (501), and a window (100) that may be sequentially laminated.

### DESCRIPTION OF SPECIFIC EMBODIMENTS

Hereinafter, a detailed description will be given of the present invention.

When a member is said to be located “on” another member in the present invention, it can be directly on the other member, or intervening members may be present therebetween.

When a portion is said to “comprise” or “include” an element in the present invention, this means that other elements may be further included, rather than excluding such other elements, unless otherwise specified.

An aspect of the present invention pertains to a hard coating film including a substrate and a hard coating layer provided on at least one surface of the substrate, in which the hard coating layer includes a cured product of a hard coating composition containing a fluorine-based UV-curable-functional-group-containing compound, a light-transmissive resin, and a fluorine-based solvent, and the fluorine-based solvent is contained in an amount of 0.1 to 40 wt % based on a total of 100 wt % of the hard coating composition.

The hard coating film according to the present invention has high hardness and is also excellent in both wear resistance and antifouling performance.

The hard coating film according to the present invention includes a substrate, specifically a transparent substrate.

The substrate may be used without particular limitation, so long as it is a substrate used in the art, and specifically, a film having superior transparency, mechanical strength, thermal stability, moisture-blocking properties, isotropic properties, etc. may be used.

More specifically, the substrate may be a film including at least one selected from among thermoplastic resins, including a polyester-based resin such as polyethylene terephthalate, polyethylene isophthalate, polyethylene naphthalate, polybutylene terephthalate and the like; a cellulose-based resin such as diacetyl cellulose, triacetyl cellulose and the like; a polycarbonate-based resin; an acrylic resin such as polymethyl (meth)acrylate, polyethyl (meth)acrylate and the like; a styrene-based resin such as polystyrene, an acrylonitrile-styrene copolymer and the like; a polyolefin-based resin such as polyethylene, polypropylene, polyolefin having a cyclic or norbomene structure, an ethylene-propylene copolymer and the like; a vinyl-chloride-based resin; an amide-based resin such as nylon, aromatic polyamide and the like; an imide-based resin; a sulfone-based resin; a polyethersulfone-based resin; a polyetheretherketone-based resin; a polyphenylene-sulfide-based resin; a vinyl-alcohol-based resin; a vinylidene-chloride-based resin; a vinyl-butyral-based resin; an allylate-based resin; a polyoxymethylene-based resin; an epoxy-based resin, and the like, and a film including a blend of thermoplastic resins may be used. Also, a film including a (meth)actyl-, urethane-, acrylurethane-, epoxy-, or silicone-based thermosetting resin and/or UV-curable resin may be used. According to an embodiment of the present invention, it is possible to use a polyimide-based resin, which has superior resistance to repeated bending and may thus be more easily applied to a flexible image display device, or alternatively, a polyimide-based resin film or a polyester-based resin film may be used therewith.

The thickness of the substrate may be 20 to 100 μm, and preferably 30 to 80 μm. When the thickness of the substrate falls within the above range, the strength of the hard coating film including the same may be enhanced and thus processability may be increased, transparency may be prevented from decreasing, and the film may be lightweight.

The hard coating film according to the present invention may include a hard coating layer provided on at least one surface of the substrate, and the hard coating layer preferably includes a cured product of a hard coating composition containing a fluorine-based UV-curable-functional-group-containing compound, a light-transmissive resin, and a fluorine-based solvent. Here, the fluorine-based solvent is contained in an amount of 0.1 to 40 wt % based on a total of 100 wt % of the hard coating composition.

The fluorine-based UV-curable-functional-group-containing compound, which is a component that imparts antifouling performance and wear resistance, is not particularly limited, so long as it contains fluorine and also has a UV-curable functional group.

In another embodiment of the present invention, the fluorine-based UV-curable-functional-group-containing compound may include at least one selected from the group consisting of a perfluoro-alkyl-group-containing (meth)acrylate, a perfluoro-polyether-group-containing (meth)acrylate, a perfluoro-cycloaliphatic-group-containing (meth)acrylate, and a perfluoro-aromatic-group-containing (meth)acrylate. Here, it is preferable because it exhibits superior antifouling performance and simultaneously has an advantage of superior durability that maintains antifouling performance for a long time even after repeated use by forming a chemical bond with the hard coating layer.

In another embodiment of the present invention, the fluorine-based UV-curable-functional-group-containing compound may be contained in an amount of 0.01 to 30 wt %, preferably 0.01 to 20 wt %, and more preferably 0.01 to 10 wt %, based on a total of 100 wt % of solid content of the hard coating composition. When the amount of the fluorine-based UV-curable-functional-group-containing compound falls within the above range, superior wear resistance and a superior antifouling effect may be desirably imparted thereto. If the amount of the UV-curable-functional-group-containing compound is less than the above lower limit, it may be somewhat difficult to achieve sufficient wear resistance or antifouling performance. On the other hand, if the amount thereof exceeds the above upper limit, properties of film hardness or scratch resistance may be somewhat deteriorated.

As commercial products of the fluorine-based UV-curable compound, KY-1203, available from Shin-Etsu Chemical, FS-7025, FS-7026, FS-7031, and FS-7032 available from Fluoro Technology, and the like, may be used, but the present invention is not limited thereto.

The hard coating composition according to the present invention includes a light-transmissive resin.

In the present invention, the light-transmissive resin is a photocurable resin, and the photocurable resin may include a photocurable (meth)acrylate oligomer and/or monomer, but is not limited thereto.

The photocurable (meth)acrylate oligomer includes epoxy (meth)acrylate, urethane (meth)acrylate, ester (meth)acrylate, and the like, and urethane (meth)acrylate is more preferable.

The urethane (meth)acrylate may be prepared from a multifunctional (meth)acrylate having a hydroxyl group in the molecule and a compound having an isocyanate group in the presence of a catalyst.

Specific examples of the (meth)acrylate having a hydroxyl group in the molecule may include at least one selected from the group consisting of 2-hydroxyethyl (meth)acrylate, 2-hydroxyisopropyl (meth)acrylate, 4-hydroxybutyl (meth)acrylate, caprolactone ring-opened hydroxyacrylate, pentaerythritol tri/tetra(meth)acrylate mixtures, and dipentaerythritol penta/hexa(meth)acrylate mixtures.

Specific examples of the compound having an isocyanate group may include at least one selected from the group consisting of 1,4-diisocyanatobutane, 1,6-diisocyanatohexane, 1,8-diisocyanatooctane, 1,12-diisocyanatododecane, 1,5-diisocyanato-2-methylpentane, trimethyl-1,6-diisocyanatohexane, 1,3-bis(isocyanatomethyl)cyclohexane, trans-1,4-cyclohexene diisocyanate, 4,4′-methylenebis(cyclohexyl isocyanate), isophorone diisocyanate, toluene-2,4-diisocyanate, toluene-2,6-diisocyanate, xylene-1,4-diisocyanate, tetramethylxylene-1,3-diisocyanate, 1-chloromethyl-2,4-diisocyanate, 4,4′-methylenebis(2,6-dimethylphenyl isocyanate), 4,4′-oxybis(phenyl isocyanate), trifunctional isocyanate derived from hexamethylene diisocyanate, and trimethylene propanol adduct toluene diisocyanate.

The monomer that is used may be a typical one, and examples of the photocurable functional group may include those having an unsaturated group such as a (meth)acryloyl group, a vinyl group, a styryl group, an allyl group, etc. in the molecule, and among these, a (meth)acryloyl group is preferable.

Specific examples of the monomer having a (meth)acryloyl group may include at least one selected from the group consisting of neopentyl glycol acrylate, 1,6-hexanediol (meth)acrylate, propylene glycol di(meth)acrylate, triethylene glycol di(meth)acrylate, dipropylene glycol di(meth)acrylate, polyethylene glycol di(meth)acrylate, polypropylene glycol di(meth)acrylate, trimethylolpropane tri(meth)acrylate, trimethylolethane tri(meth)acrylate, 1,2,4-cyclohexane tetra(meth)acrylate, pentaglycerol tri(meth)acrylate, pentaerythritol tetra(meth)acrylate, pentaerythritol tri(meth)acrylate, dipentaerythritol tri(meth)acrylate, dipentaerythritol penta(meth)acrylate, dipentaerythritol tetra(meth)acrylate, dipentaerythritol hexa(meth)acrylate, tripentaerythritol tri(meth)acrylate, tfipentaerythritol hexa tri(meth)acrylate, bis(2-hydroxyethyl)isocyanurate di(meth)acrylate, hydroxyethyl (meth)acrylate, hydroxypropyl (meth)acrylate, hydroxybutyl (meth)acrylate, isooctyl (meth)acrylate, isodecyl (meth)acrylate, stearyl (meth)acrylate, tetrahydrofurfuryl (meth)acrylate, phenoxyethyl (meth)acrylate, and isobomeol (meth)acrylate.

As the light-transmissive resin listed above, the photocurable (meth)acrylate oligomer and monomer may be used alone or in combinations of two or more thereof.

The amount of the light-transmissive resin is not particularly limited but is 1 to 80 wt %, preferably 10 to 80 wt %, and more preferably 10 to 70 wt %, based on a total of 100 wt % of the hard coating composition. When the amount of the light-transmissive resin falls within the above range, hardness may be sufficiently increased, and curling may be suppressed.

The fluorine-based solvent may serve to increase the solubility of the fluorine-based UV-curable-functional-group-containing compound, thereby maintaining superior wettability of the resulting hard coating film and the coating state of the film, and forming a high-concentration fluorine component layer on the surface of the hard coating layer by aligning the fluorine-based UV-curable functional group on the surface of the hard coating layer during the coating and drying processes.

The fluorine-based solvent is contained in an amount of 0.1 to 40 wt % based on a total of 100 wt % of the hard coating composition.

In another embodiment of the present invention, the fluorine-based solvent is preferably contained in an amount of 0.1 to 30 wt %, and more preferably 1 to 20 wt %.

When the amount of the fluorine-based solvent falls within the above range, sufficient surface floatation of the fluorine-based UV-curable-functional-group-containing compound may be achieved, and the wettability and the coating state of the film may also be superior, which is desirable.

In another embodiment of the present invention, the fluorine-based solvent may include at least one selected from the group consisting of perfluorohexylethyl alcohol, perfluoroether, and perfluorohexane.

Specifically, the fluorine-based solvent may be at least one selected from among Chemical Formulas 1 to 8 below.

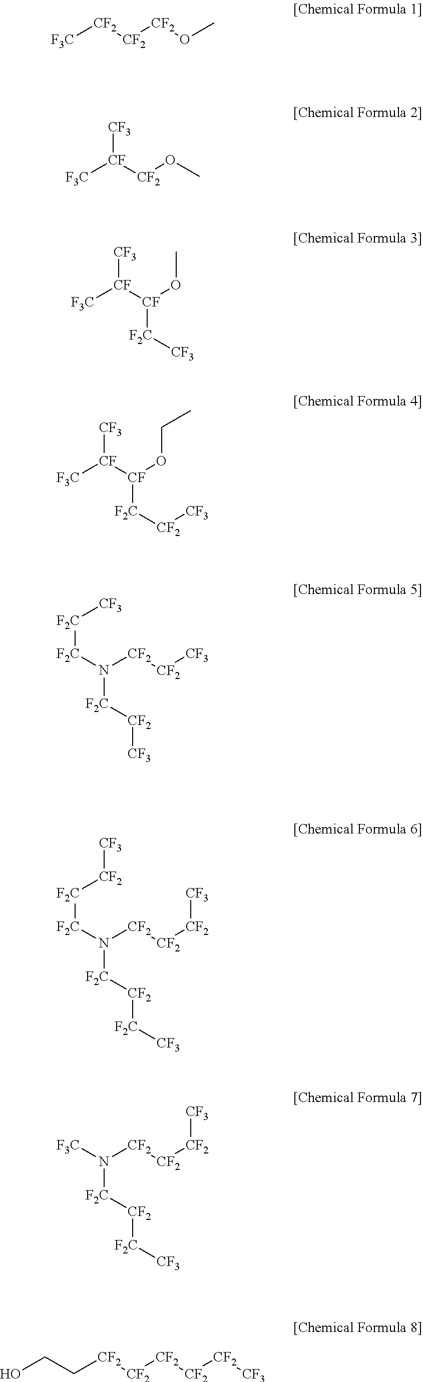

Commercial fluorine-based solvent products include FIFE-7100, HFE-7300, HFE-7500, FC-3283, FC-40, and FC-770, available from 3M, C6FOH-BF available from Nika, and the like, but are not limited thereto.

In another embodiment of the present invention, the hard coating composition may further include at least one selected from the group consisting of a photoinitiator, an additional solvent, and an additive.

The photoinitiator may be used without limitation, so long as it is commonly used in the art. For example, it may include at least one selected from the group consisting of hydroxyketones, aminoketones, hydrogen-abstraction-type photoinitiators, and combinations thereof.

Specifically, the photoinitiator may include at least one selected from the group consisting of 2-methyl-1-[4-(methylthio)phenyl]-2-morpholine propanone-1, diphenyl ketone, benzyl dimethyl ketal, 2-hydroxy-2-methyl-1-phenyl-1-one, 4-hydroxy cyclophenyl ketone, 2,2-dimethoxy-2-phenyl-acetophenone, anthraquinone, fluorene, triphenylamine, carbazole, 3-methylacetophenone, 4-chloroacetophenone, 4,4-dimethoxyacetophenone, 4,4-diaminobenzophenone, 1-hydroxycyclohexyl phenyl ketone, benzophenone, diphenyl(2,4,6-trimethylbenzoyl)phosphine oxide, and combinations thereof.

The photoinitiator may be used in an amount of 0.1 to 10 wt %, preferably 1 to 8 wt %, and more preferably 1 to 6 wt %, based on a total of 100 wt % of the hard coating composition. When the amount of the photoinitiator falls within the above range, the curing speed is high, and the formation of uncured portions is prevented, so superior mechanical properties may be obtained, and the coating film may be prevented from cracking due to overcuring, which is desirable.

The hard coating composition may further include an additional solvent in addition to the fluorine-based solvent. The additional solvent is not particularly limited, and those typically used in the art may be used without limitation. Specifically, the additional solvent may include, but is not limited to, alcohols (e.g., methanol, ethanol, isopropanol, butanol, methyl cellosolve, ethyl cellosolve, and the like), ketones (e.g., methyl ethyl ketone, methyl butyl ketone, methyl isobutyl ketone, diethyl ketone, dipropyl ketone, cyclohexanone, and the like), hexanes (hexane, heptane, octane and the like), benzenes (benzene, toluene, xylene and the like), etc.

The amount of the additional solvent may be 10 to 95 wt %, preferably 10 to 80 wt %, and more preferably 20 to 60 wt %, based on a total of 100 wt % of the hard coating composition. When the amount of the additional solvent falls within the above range, appropriate viscosity may be obtained and thus high workability may result, and moreover, the substrate film may be sufficiently swelled, and the processing time may be reduced in the king process, thus generating economic benefits. Hence, it is preferred that the additional solvent be used within the above range.

The additive may specifically be a UV stabilizer, a heat stabilizer, etc., but is not limited thereto, and an additive commonly used in the art may be used within a range that does not impair the purposes of the present invention.

Specifically, the hard coating composition according to the present invention may further include a UV stabilizer, a heat stabilizer, and the like.

The UV stabilizer is an additive added for the purpose of protecting the adhesive by blocking or absorbing UV rays because the surface of the cured coating film decomposes and becomes discolored and brittle upon continuous UV exposure.

The UV stabilizer may include at least one selected from among an absorber, a quencher, and a hindered amine light stabilizer (HALS), as classified depending on the mechanism of action thereof, or may include at least one selected from among phenyl salicylate (absorber), benzophenone (absorber), benzotriazole (absorber), a nickel derivative (quencher), and a radical scavenger, as classified depending on the chemical structure thereof. In addition, a UV stabilizer commonly used in the art may be used.

The heat stabilizer may include at least one selected from among a polyphenol-based primary heat stabilizer, a phosphite-based secondary heat stabilizer, and a lactone-based secondary heat stabilizer, as commercially applicable products, but is not limited thereto.

The UV stabilizer and the heat stabilizer may be used by appropriately adjusting the amounts thereof so as not to affect UV curability.

The hard coating composition according to the present invention may further include a polymer compound, a photostimulator, an antioxidant, a UV absorber, a thermal polymerization inhibitor, a surfactant, a lubricant, an antifouling agent and the like, which are commonly used in the art within a range that does not impair the effects of the present invention, in addition to the above components. Here, the type and amount of each additive may be appropriately selected by those of ordinary skill in the art.

In another embodiment of the present invention, the hard coating layer may have a water contact angle of 100° or more. In the present invention, the water contact angle refers to the angle at which a water droplet touches the surface of the hard coating layer when the water droplet is dropped on the surface of the hard coating layer. As the water contact angle is higher, it is difficult for foreign matter to adhere to the coating surface, so antifouling performance such as fingerprint protection becomes superior. Furthermore, surface alignment of the fluorine material due to the fluorine-based solvent is increased, whereby not only initial antifouling performance, but also retention of antifouling performance, that is, wear resistance, are further increased.

Briefly, the hard coating layer according to the present invention may have a water contact angle of 100° or more, thereby exhibiting superior wear resistance and antifouling performance.

Preferably, the hard coating layer according to the present invention has a water contact angle of 105° or more, and more preferably 108° or more.

In another embodiment of the present invention, the hard coating layer may have a contact angle of 100° or more after being rubbed 3000 times using an eraser under a load of 1 kg. The hard coating layer preferably has a contact angle of 102° or more, and more preferably 105° or more, after being rubbed 3000 times using an eraser under a load of 1 kg.

Briefly, the hard coating layer according to the present invention is vastly superior in ability to maintain wear resistance and antifouling performance.

The hard coating film according to the present invention may be formed by applying the hard coating composition as described above on one or both surfaces of the substrate and then performing curing.

When forming a hard coating film using the hard coating composition as described above, superior wear resistance and antifouling performance may be simultaneously realized through a single coating process, that is, a process of forming a monolayered hard coating layer, and wear resistance and antifouling performance may be maintained even when the hard coating film is rubbed, and moreover, high hardness may be exhibited.

Briefly, a hard coating film including a hard coating layer including a cured product of the hard coating composition according to the present invention exhibits high hardness and has superior wear resistance and antifouling performance.

The hard coating layer may be formed through an appropriate process selected from among die coating, air-knife coating, reverse-roll coating, spray coating, blade coating, casting, gravure coating, microgravure coating, and spin coating.

The thickness of the coating layer may be 1 μm to 200 μm, particularly 3 μm to 100 μm, and more particularly 3 μm to 30 μm, but is not limited thereto. However, when the thickness of the coating layer satisfies the above range, it is possible to manufacture a hard coating film that is both hard and flexible, is capable of being formed thinly, and maintains wear resistance and antifouling performance. The thickness of the coating layer is the thickness after drying.

The hard coating composition that is applied is dried through evaporation of volatile materials for 10 sec to 1 hr, and particularly 30 sec to 10 min, at a temperature of 30 to 150° C. Thereafter, the hard coating composition is irradiated with UV light and cured. Here, the dose of UV light may be about 200 to 2000 mJ/cm², and particularly 200 to 1500 mJ/cm².

The hard coating film may be used for a flexible display, and specifically, it may be used to replace a touch panel for displays such as LCDs, OLEDs, LEDs, FEDs, etc., various mobile communication terminals using the same, smartphones or tablet PCs, and a cover glass for electronic paper, or may be used as a functional layer.

Another aspect of the present invention pertains to a window including the hard coating film as described above.

The window may serve to protect elements included in the image display device from external impacts or changes in ambient temperature and humidity, and a light-blocking pattern may be further formed on the periphery of one surface of the window. The light-blocking pattern may include, for example, a printed color pattern, and may have a monolayer structure or a multilayer structure. A bezel portion or a non-display region of the image display device may be defined by the light-blocking pattern.

Still another aspect of the present invention pertains to an image display device including the window 100 and a display panel 200, and further including a touch sensor 300 and a polarizing plate 400 between the window 100 and the display panel 200.

The image display device may include a liquid crystal display device, an OLED, a flexible display, and the like, but is not limited thereto, and all image display devices known in the art may be applicable.

The display panel 200 may include a pixel electrode, a pixel definition film, a display layer, a counter electrode, and an encapsulation layer disposed on a panel substrate, but is not limited thereto. As necessary, elements used in the art may be further included.

As an example, a pixel circuit including a thin-film transistor (TFT) may be formed on the panel substrate, and an insulating film may be formed to cover the pixel circuit. Here, the pixel electrode may be electrically connected to, for example, a drain electrode of the TFT on the insulating film. The pixel definition film may be formed on the insulating film to expose the pixel electrode to thereby define a pixel region. A display layer may be formed on the pixel electrode, and the display layer may include, for example, a liquid crystal layer or an organic light-emitting layer. A counter electrode may be disposed on the pixel definition film and the display layer, and the counter electrode may be provided, for example, as a common electrode or a cathode of the image display device. An encapsulation layer protecting the display panel may be laminated on the counter electrode.

The touch sensor 300 is used as input means. As the touch sensor 300, for example, various types thereof, such as a resistive film type, a surface-elastic-wave type, an infrared-ray type, an electromagnetic induction type, a capacitive type and the like are proposed. The type thereof is not particularly limited in the present invention, but a capacitive type is particularly preferred.

The capacitive touch sensor is divided into an active region and an inactive region located outside the active region. The active region is a region corresponding to a region (display part) in which the screen is displayed on the display panel, and is a region in which a user's touch is sensed, and the inactive region is a region corresponding to a region (non-display part) in which the display device screen is not displayed. The touch sensor includes a flexible substrate, a sensing pattern formed on the active region of the substrate, and individual sensing lines formed on the inactive region of the substrate and connected to an external driving circuit through the sensing pattern and the pad part. As the flexible substrate, the same material as the transparent substrate of the window may be used. Meanwhile, toughness is defined as the area beneath a stress-strain curve (%) obtained through a tensile test conducted on a polymer material to the point of failure. The touch sensor substrate preferably has a toughness of 2,000 MPa % or more in view of suppressing cracking of the touch sensor. More preferably, the toughness thereof is 2,000 MPa % to 30,000 MPa %.

The sensing pattern may include a first pattern formed in a first direction and a second pattern formed in a second direction. The first pattern and the second pattern are arranged in different directions. The first pattern and the second pattern are formed on the same layer and have to be electrically connected in order to sense a touched point. In the first pattern, individual unit patterns are connected to each other through a joint, but in the second pattern, individual unit patterns are separated from each other in an island form, and thus a separate bridge electrode is required in order to realize electrical connection of the second pattern. As the sensing pattern, a known transparent electrode material may be applied. For example, indium tin oxide (ITO), indium zinc oxide (IZO), zinc oxide (ZnO), indium zinc tin oxide (IZTO), cadmium tin oxide (CTO), poly(3,4-ethylenedioxythiophene) (PEDOT), carbon nanotubes (CNTs), graphene, metal wires, and the like may be used alone or in combinations of two or more thereof. ITO is preferably used. The metal used for the metal wires is not particularly limited, and examples thereof include silver, gold, aluminum, copper, iron, nickel, titanium, tellurium, chromium, and the like, which may be used alone or in combinations of two or more thereof.

The bridge electrode may be formed on an insulating layer by disposing the insulating layer on the sensing pattern, the bridge electrode may be formed on the substrate, and the insulating layer and the sensing pattern may be formed thereon. The bridge electrode may be formed of the same material as the sensing pattern, and may also be formed of a metal such as molybdenum, silver, aluminum, copper, palladium, gold, platinum, zinc, tin, titanium, or an alloy of two or more thereof. Since the first pattern and the second pattern need to be electrically insulated from each other, the insulating layer is formed between the sensing pattern and the bridge electrode. The insulating layer may be formed only between the joint of the first pattern and the bridge electrode, or may be formed in a layer structure covering the sensing pattern. In the latter case, the bridge electrode may connect the second pattern through a contact hole formed in the insulating layer. As means for appropriately compensating for the difference in transmittance between the pattern region in which the sensing pattern is formed and the non-pattern region in which the pattern is not formed, particularly a difference in light transmittance due to the difference in refractive index therebetween, an optical control layer may be further included between the substrate and the electrode. The optical control layer may be formed by applying a photocurable composition including a photocurable organic binder on a substrate. The photocurable composition may further include inorganic particles. The refractive index of the optical control layer may be increased by the inorganic particles.

The photocurable organic binder may include, for example, a copolymer of monomers such as an acrylate-based monomer, a styrene-based monomer, a carboxylic-acid-based monomer and the like. The photocurable organic binder may be, for example, a copolymer including different repeating units such as an epoxy-group-containing repeating unit, an acrylate repeating unit, a carboxylic-acid repeating unit and the like.

The inorganic particles may include, for example, zirconia particles, titania particles, alumina particles, and the like. The photocurable composition may further include various additives such as a photopolymerization initiator, a polymerizable monomer, a curing assistant, and the like.

The polarizing plate 400 may be configured to include a polarizer alone or a polarizer and a transparent substrate attached to at least one surface thereof. Depending on the polarization state of the light that is emitted through the polarizing plate, the polarizing plate is classified into a linear polarizing plate, a circular polarizing plate, and the like. Hereinafter, although not particularly limited in the present description, a circular polarizing plate that is capable of being used to improve visibility by absorbing reflected light is described in detail.

A circular polarizing plate is a functional layer having a function of transmitting only a right or left circularly polarized light component by laminating a λ/4 retardation plate on a linear polarizing plate. For example, the circular polarizing plate converts external light into right circularly polarized light and reflects the external light from the organic EL panel to block left circularly polarized external light, and transmits only the light-emitting component of the organic EL to suppress the influence of the reflected light, thereby making an image easy to see. In order to achieve the circular polarization function, the absorption axis of the linear polarizing plate and the slow axis of the λ/₄ retardation plate have to be 45° in theory, but may be 45±10° in practice. The linear polarizing plate and the λ/4 retardation plate do not necessarily need to be laminated adⱼacent to each other, so long as the relationship between the absorption axis and the slow axis satisfies the above range. It is preferable to achieve complete circular polarization at all wavelengths, but the circular polarizing plate of the present invention may also include an elliptical polarizing plate because it is not always necessary in practice. Preferably, a λ/4 retardation film is laminated so as to be closer to the viewing side of the linear polarizing plate, thus making the emitted light circularly polarized, thereby increasing visibility in the state in which polarized sunglasses are worn.

The linear polarizing plate is a functional layer that allows light vibrating in the direction of the transmission axis to pass therethrough but blocks polarized light having a vibrational component perpendicular thereto. The linear polarizing plate may be configured to include a linear polarizer alone or a linear polarizer and a protective film attached to at least one surface thereof. The thickness of the linear polarizing plate may be 200 μm or less, and preferably 0.5 μm to 100 μm. If the thickness thereof exceeds 200 μm, flexibility may decrease.

The linear polarizer may be a film-type polarizer manufactured by dyeing and stretching a polyvinyl alcohol (PVA)-based film. A dichroic dye such as iodine is adsorbed into the PVA-based film aligned through stretching, or is stretched in the state of being adsorbed to PVA, whereby the dichroic dye is aligned, thus exhibiting polarization performance. The manufacture of the film-type polarizer may include other steps such as swelling, crosslinking with boric acid, washing with an aqueous solution, drying, and the like. The stretching and dyeing processes may be carried out using the PVA-based film alone, or may be conducted in the state in which the PVA-based film is laminated with another film such as one made of polyethylene terephthalate. The PVA-based film that is used preferably has a thickness of 10 to 100 μm, and the stretching ratio thereof is 2 to 10 times.

Moreover, another example of the polarizer may be a liquid-crystal-application-type polarizer formed by applying a liquid crystal polarization composition. The liquid crystal polarization composition may include a liquid crystal compound and a dichroic dye compound. It is sufficient for the liquid crystal compound to have a property of exhibiting a liquid crystal state, and in particular, a compound having a high-order alignment state such as a smectic phase is preferable because it may exhibit high polarization performance. It is also preferable to have a polymerizable functional group. The dichroic dye compound is a dye exhibiting dichroism by being aligned with the liquid crystal compound, and may have a polymerizable functional group, or the dichroic dye itself may have liquid crystallinity. Any one compound of the liquid crystal polarization composition has a polymerizable functional group, and the liquid crystal polarization composition may include an initiator, a solvent, a dispersant, a leveling agent, a stabilizer, a surfactant, a crosslinking agent, a silane-coupling agent, and the like. The liquid-crystal-application-type polarizer may be manufactured by applying the liquid crystal polarization composition on an alignment film to form a liquid crystal polarizer. The liquid-crystal-application-type polarizer may be formed to be thinner than the film-type polarizer. The liquid-crystal-application-type polarizer may have a thickness of 0.5 to 10 μm, and preferably 1 to 5 μm.

The alignment film may be manufactured by, for example, applying an alignment-film-forming composition on a substrate and performing alignment through rubbing, irradiation with polarized light, or the like. The alignment-film-foming composition includes an alignment agent, and may further include a solvent, a crosslinking agent, an initiator, a dispersant, a leveling agent, a silane-coupling agent, and the like. As the alignment agent, for example, polyvinyl alcohol, polyacrylates, polyamic acids, and polyimides may be used. When performing light alignment, it is preferable to use an aligning agent containing a cinnamate group. The polymer used as the alignment agent may have a weight average molecular weight of about 10,000 to 1,000,000. The thickness of the alignment film is preferably 5 nm to 10,000 nm, and particularly 10 to 500 nm, within which range the alignment control force is sufficiently exhibited. The liquid crystal polarizer may be peeled off from the substrate, transferred and laminated, or the substrate may be laminated as it is. The case in which the substrate serves as a protective film, a retardation plate, or a transparent substrate for a window is also preferable.

The protective film may be a transparent polymer film, and materials and additives used for transparent substrates may be used. For a transparent substrate, reference may be made to the above description.

The λ/4 retardation plate is a film that imparts λ/₄ retardation in a direction orthogonal to the traveling direction of incident light (i.e. the in-plane direction of the film). The λ/4 retardation plate may be a stretchable retardation plate manufactured by stretching a polymer film such as a cellulose-based film, an olefin-based film, a polycarbonate-based film, etc. As necessary, a retardation adjuster, a plasticizer, a UV absorber, an infrared absorber, a colorant such as a pigment or a dye, a fluorescent brightener, a dispersant, a heat stabilizer, a light stabilizer, an antistatic agent, an antioxidant, a lubricant, a solvent, and the like may be included. The thickness of the stretchable retardation plate is 200 μm or less, and preferably 1 μm to 100 μm. If the thickness thereof exceeds 200 μm, flexibility may decrease.

Also, another example of the λ/₄ retardation plate may be a liquid-crystal-application-type retardation plate formed by applying a liquid crystal composition. The liquid crystal composition includes a liquid crystal compound having a property of exhibiting a liquid crystal state, such as a nematic, cholesteric, or smectic state. Any one compound including a liquid crystal compound in the liquid crystal composition has a polymerizable functional group. The liquid-crystal-application-type retardation plate may further include an initiator, a solvent, a dispersant, a leveling agent, a stabilizer, a surfactant, a crosslinking agent, a silane-coupling agent, and the like. The liquid-crystal-application-type retardation plate may be manufactured by applying the liquid crystal composition on an alignment film and performing curing to form a liquid crystal retardation layer, as described in the liquid crystal polarizer above. The liquid-crystal-application-type retardation plate may be formed to be thinner than the stretchable retardation plate. The thickness of the liquid crystal retardation layer is 0.5 to 10 μm, and preferably 1 to 5 μm. The liquid-crystal-application-type retardation plate may be peeled off from the substrate, transferred, and laminated, or the substrate may be laminated as it is. The case in which the substrate serves as a protective film, a retardation plate, or a transparent substrate for a window is also preferable.

In general, there are many materials that exhibit greater birefringence at shorter wavelengths and smaller birefringence at longer wavelengths. Here, since λ/4 retardation cannot be achieved in the entire visible light range, in-plane retardation is preferably designed to be 100 to 180 nm, and more preferably 130 to 150 nm, so that it is λ/4 in the vicinity of 560 nm, at which visibility is high. An inverse dispersion λ/4 retardation plate using a material having birefringence wavelength dispersion characteristics opposite normal characteristics is preferable because visibility may be further improved. As such materials, the stretchable retardation plate may be that described in Japanese Patent Application Publication No. 2007-232873, and the liquid-crystal-application-type retardation plate may be that described in Japanese Patent Application Publication No. 2010-30979.

As another method, a technique for obtaining a broadband λ/4 retardation plate through coupling with a λ/2 retardation plate is also known (Japanese Patent Application Publication No. 1998-90521). The λ/2 retardation plate is also manufactured using the same material and method as the λ/4 retardation plate. Although the combination of the stretchable retardation plate and the liquid-crystal-application-type retardation plate is optional, it is preferable to use the liquid-crystal-application-type retardation plate for both, because the thickness may be reduced.

There is known a method of laminating a positive C plate on a circular polarizing plate in order to increase visibility in an oblique direction (Japanese Patent Application Publication No. 2014-224837). The positive C plate may be a liquid-crystal-application-type retardation plate or a stretchable retardation plate. Retardation in the thickness direction of the retardation plate may be −200 to −20 nm, and preferably −140 to −40 nm.

The aforementioned elements and members (such as the circular polarizing plate, linear polarizing plate, retardation plate, etc.) constituting elements (the window, display panel, touch sensor, polarizing plate, etc.) may be directly bonded to each other, and for bonding, an adhesive layer or a pressure-sensitive adhesive layer 501, 502 may be further included between the elements or members.

The type of adhesive layer or pressure-sensitive adhesive layer 501, 502 is not particularly limited in the present invention, and examples of the adhesive may include an aqueous adhesive, an organic-solvent-type adhesive, a solvent-free adhesive, a solid adhesive, an aqueous-solvent-volatilization-type adhesive, a moisture-curing-type adhesive, a thermosetting adhesive, an anaerobic-curing-type adhesive, an active-energy-ray-curing-type adhesive, an adhesive mixed with a curing agent, a hot-melt-type adhesive, a pressure-sensitive-type adhesive (i.e. a pressure-sensitive adhesive), a remoistening-type adhesive, a pressure-sensitive adhesive, etc., which may be used for general purposes. Among these, an aqueous-solvent-volatilization-type adhesive, an active-energy-ray-curing-type adhesive, and a pressure-sensitive adhesive are frequently used. The thickness of the adhesive layer may be appropriately adjusted depending on the required adhesion and the like, and is 0.01 μm to 500 μm, and preferably 0.1 μm to 300 μm. Multiple adhesive layers may be present in the image display device, but the thickness and type of each adhesive layer may be the same or different.

As the aqueous-solvent-volatilization-type adhesive, a resin polymer dispersed in water, such as a polyvinyl-alcohol-based polymer, a water-soluble polymer such as starch, an ethylene-vinyl acetate-based emulsion, a styrene-butadiene-based emulsion and the like may be used. In addition to the resin polymer and water, a crosslinking agent, a silane-based compound, an ionic compound, a crosslinking catalyst, an antioxidant, a dye, a pigment, an inorganic filler, an organic solvent and the like may be included. Upon bonding with the aqueous-solvent-volatilization-type adhesive, the aqueous-solvent-volatilization-type adhesive may be injected between the adhered layers, and the adhered layers may be bonded and dried to realize adhesion. In the case of using the aqueous-solvent-volatilization-type adhesive, the thickness of the adhesive layer may be 0.01 to 10 μm, and preferably 0.1 to 1 μm. When the aqueous-solvent-volatilization-type adhesive is used in multiple layers, the thickness and type of each layer may be the same or different.

The active-energy-ray-curing-type adhesive may be formed by curing an active-energy-ray-curable composition including a reactive material that forms an adhesive layer through irradiation with active energy rays. The active-energy-ray-curable composition may contain at least one polymer of a radical polymerizable compound and a cationic polymerizable compound, as in the hard coating composition. As the radical polymerizable compound, the same compound as that in the hard coating composition may be used, and the same type as the hard coating composition may be used. The radical polymerizable compound used for the adhesive layer is preferably a compound having an acryloyl group. It is also preferable to include a monofunctional compound in order to lower the viscosity of the adhesive composition.

As the cationic polymerizable compound, the same compound as that in the hard coating composition may be used, and the same type as the hard coating composition may be used. The cationic polymerizable compound used for the active-energy-ray-curable composition is particularly preferably an epoxy compound. It is also preferable to include a monofunctional compound as a reaction diluent in order to lower the viscosity of the adhesive composition.

The active energy ray composition may further include a polymerization initiator. For the polymerization initiator, reference may be made to the above description.

The active-energy-ray-curable composition may also include an ion scavenger, an antioxidant, a chain transfer agent, an adhesion-imparting agent, a thermoplastic resin, a filler, a flow viscosity modifier, a plasticizer, a defoaming agent, an additive, and a solvent. When performing bonding using the active-energy-ray-curing-type adhesive, the active-energy-ray-curable composition may be applied onto one or both of the adhered layers and then combined, after which one adhered layer or two adhered layers may be irradiated with active energy rays, cured and bonded. When using the active-energy-ray-curing-type adhesive, the thickness of the adhesive layer is 0.01 to 20 μm, and preferably 0.1 to 10 μm. When the active-energy-ray-curing-type adhesive is used in multiple layers, the thickness and type of each layer may be the same or different.

As the pressure-sensitive adhesive, any pressure-sensitive adhesive, classified as an acrylic pressure-sensitive adhesive, a urethane-based pressure-sensitive adhesive, a rubber pressure-sensitive adhesive, a silicone pressure-sensitive adhesive or the like, depending on the type of resin polymer, may be used. In addition to the resin polymer, a crosslinking agent, a silane-based compound, an ionic compound, a crosslinking catalyst, an antioxidant, a tackifier, a plasticizer, a dye, a pigment, an inorganic filler, and the like may be included in the pressure-sensitive adhesive. Each component constituting the pressure-sensitive adhesive is dissolved and dispersed in a solvent to afford a pressure-sensitive adhesive composition, and the pressure-sensitive adhesive composition is applied onto a substrate and dried to form a pressure-sensitive adhesive layer. The pressure-sensitive adhesive layer may be formed directly on the substrate, or may be separately formed on another substrate and transferred. It is also preferable to use a release film in order to cover the adhesive surface before bonding. When using the pressure-sensitive adhesive, the thickness of the pressure-sensitive adhesive layer may be 1 to 500 μm, and preferably 2 to 300 μm. When the pressure-sensitive adhesive is used in multiple layers, the thickness and type of each layer may be the same or different.

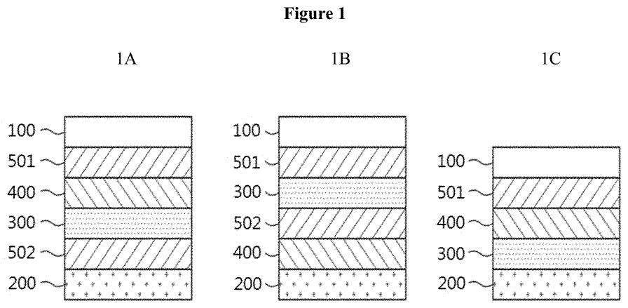

The order of elements in the image display device of the present invention is not particularly limited in the present invention, and will be described with reference to FIGS. 1A to 1C as examples. As shown in FIG. 1A, a display panel 200, a lower adhesive layer 502, a touch sensor 300, a polarizing plate 400, an upper adhesive layer or an upper pressure-sensitive adhesive layer 501, and a window 100 may be sequentially laminated, and as shown in FIG. 1B, a display panel 200, a polarizing plate 400, a lower adhesive layer 502, a touch sensor 300, an upper adhesive layer or an upper pressure-sensitive adhesive layer 501, and a window 100 may be sequentially laminated. As shown in FIG. 1C, a display panel 200, a touch sensor 300, a polarizing plate 400, an adhesive layer or a pressure-sensitive adhesive layer 501, and a window 100 may be sequentially laminated. Here, with regard to individual elements, reference may be made to the above description.

In the image display device, as shown in FIG. 1A or 1C, the window 100, the polarizing plate 400 and the touch sensor 300 may be sequentially disposed from the user's viewing side. Here, the sensing cells of the touch sensor 300 are disposed under the polarizing plate 400, whereby pattern visibility may be more effectively prevented.

When the touch sensor 300 includes a substrate, the substrate may include, for example, triacetyl cellulose, cycloolefin, a cycloolefin copolymer, a polynorbomene copolymer, and the like, and preferably has a front retardation of ±2.5 nm or less, but is not limited thereto.

The touch sensor 300 may also be directly transferred onto the window 100 or the polarizing plate 400. Here, the image display device may be configured such that the window 100, the touch sensor 300, and the polarizing plate 400 are sequentially disposed from the user's viewing side.

The display panel 200 may be configured such that the aforementioned elements are bonded through the adhesive layer or the pressure-sensitive adhesive layer 502, as shown in FIG. 1A. Here, the adhesive layer or the pressure-sensitive adhesive layer 502 may have, for example, a viscoelasticity of about 0.2 MPa or less, preferably 0.01 to 0.15 MPa, at −20 to 80° C. In this case, noise from the display panel 200 may be blocked, and interfacial stress may be relieved during bending, thereby suppressing damage to the elements to be bonded.

The hard coating film according to the present invention satisfies the requirements for high hardness and wear resistance of the hard coating film and simultaneously has superior antifouling performance and high bending resistance, so it is applicable for a hard coating for flexible surface treatment when used on a plastic substrate.

A better understanding of the present invention may be obtained via the following examples. However, the examples of the present invention may be modified in various forms, and the scope of the present specification is not to be construed as being limited to the following examples. The examples of the present invention are provided to more fully explain the present specification to those having ordinary knowledge in the art to which the present invention pertains. Unless otherwise mentioned, “%” and “part”, indicating amounts in the following examples, are given on a weight basis.

### PREPARATION EXAMPLES

### Preparation of Hard Coating Composition

### Preparation Example 1

A hard coating composition was prepared by mixing 23 wt % of 6-functional urethane acrylate (Shin-Nakamura Chemical, U-6LPA), 23 wt % of 14-functional acrylate (Miwon Specialty Chemical, Miramer SP1106), 5 wt % of a fluorine-based solvent (Nika, C6FOH-BF), 45 wt % of methyl ethyl ketone, 3.5 wt % of 1-hydroxycyclohexylphenylketone, and 0.5 wt % of a fluorine-based UV-curable-functional-group-containing compound (Shin-Etsu Chemical, KY-1203, solid content: 20%) using a stirrer, followed by filtration using a filter made of a PP material.

### Preparation Example 2

A hard coating composition was prepared by mixing 23 wt % of 6-functional urethane aciylate (Shin-Nakamura Chemical, U-6LPA), 23 wt % of 14-functional acrylate (Miwon Specialty Chemical, Miramer SP1106), 5 wt % of a fluorine-based solvent (3M, Novec FIFE-7300), 45 wt % of methyl ethyl ketone, 3.5 wt % of 1-hydroxycyclohexylphenylketone, and 0.5 wt % of a fluorine-based UV-curable-functional-group-containing compound (Shin-Etsu Chemical, KY-1203, solid content: 20%) using a stirrer, followed by filtration using a filter made of a PP material.

### Preparation Example 3

A hard coating composition was prepared by mixing 23 wt % of 6-functional urethane aciylate (Shin-Nakamura Chemical, U-6LPA), 23 wt % of 14-functional acrylate (Miwon Specialty Chemical, Miramer SP1106), 5 wt % of a fluorine-based solvent (3M, Novec FIFE-7500), 45 wt % of methyl ethyl ketone, 3.5 wt % of 1-hydroxycyclohexylphenylketone, and 0.5 wt % of a fluorine-based UV-curable-functional-group-containing compound (Fluoro Technology, FS-7026) using a stirrer, followed by filtration using a filter made of a PP material.

### Preparation Example 4

A hard coating composition was prepared by mixing 23 wt % of 6-functional urethane aciylate (Shin-Nakamura Chemical, U-6LPA), 23 wt % of 14-functional acrylate (Miwon Specialty Chemical, Miramer SP1106), 5 wt % of a fluorine-based solvent (3M, FC-3283), 45 wt % of methyl ethyl ketone, 3.5 wt % of 1-hydroxycyclohexylphenylketone, and 0.5 wt % of a fluorine-based UV-curable-functional-group-containing compound (Fluoro Technology, FS-7026) using a stirrer, followed by filtration using a filter made of a PP material.

### Preparation Example 5

A hard coating composition was prepared by mixing 23 wt % of 6-functional urethane aciylate (Shin-Nakamura Chemical, U-6LPA), 23 wt % of 14-functional acrylate (Miwon Specialty Chemical, Miramer SP1106), 10 wt % of a fluorine-based solvent (Nika, C6FOH-BF), 40 wt % of methyl ethyl ketone, 3.5 wt % of 1-hydroxycyclohexylphenylketone, and 0.5 wt % of a fluorine-based UV-curable-functional-group-containing compound (Shin-Etsu Chemical, KY-1203) using a stirrer, followed by filtration using a filter made of a PP material.

### Preparation Example 6

A hard coating composition was prepared by mixing 23 wt % of 6-functional urethane aciylate (Shin-Nakamura Chemical, U-6LPA), 23 wt % of 14-functional acrylate (Miwon Specialty Chemical, Miramer SP1106), 10 wt % of a fluorine-based solvent (3M, Novec FIFE-7300), 40 wt % of methyl ethyl ketone, 3.5 wt % of 1-hydroxycyclohexylphenylketone, and 0.5 wt % of a fluorine-based UV-curable-functional-group-containing compound (Shin-Etsu Chemical, KY-1203) using a stirrer, followed by filtration using a filter made of a PP material.

### Preparation Example 7

A hard coating composition was prepared by mixing 23 wt % of 6-functional urethane aciylate (Shin-Nakamura Chemical, U-6LPA), 23 wt % of 14-functional acrylate (Miwon Specialty Chemical, Miramer SP1106), 10 wt % of a fluorine-based solvent (3M, Novec FIFE-7500), 40 wt % of methyl ethyl ketone, 3.5 wt % of 1-hydroxycyclohexylphenylketone, and 0.5 wt % of a fluorine-based UV-curable-functional-group-containing compound (Fluoro Technology, FS-7026) using a stirrer, followed by filtration using a filter made of a PP material.

### Preparation Example 8

A hard coating composition was prepared by mixing 23 wt % of 6-functional urethane aciylate (Shin-Nakamura Chemical, U-6LPA), 23 wt % of 14-functional acrylate (Miwon Specialty Chemical, Miramer SP1106), 10 wt % of a fluorine-based solvent (3M, FC-3283), 40 wt % of methyl ethyl ketone, 3.5 wt % of 1-hydroxycyclohexylphenylketone, and 0.5 wt % of a fluorine-based UV-curable-functional-group-containing compound (Fluoro Technology, FS-7026) using a stirrer, followed by filtration using a filter made of a PP material.

### Preparation Example 9

A hard coating composition was prepared by mixing 23 wt % of 6-functional urethane aciylate (Shin-Nakamura Chemical, U-6LPA), 23 wt % of 14-functional acrylate (Miwon Specialty Chemical, Miramer SP1106), 15 wt % of a fluorine-based solvent (Nika, C6FOH-BF), 35 wt % of methyl ethyl ketone, 3.5 wt % of 1-hydroxycyclohexylphenylketone, and 0.5 wt % of a fluorine-based UV-curable-functional-group-containing compound (Shin-Etsu Chemical, KY-1203, solid content: 20%) using a stirrer, followed by filtration using a filter made of a PP material.

### Preparation Example 10

A hard coating composition was prepared by mixing 23 wt % of 6-functional urethane aciylate (Shin-Nakamura Chemical, U-6LPA), 23 wt % of 14-functional acrylate (Miwon Specialty Chemical, Miramer SP1106), 15 wt % of a fluorine-based solvent (3M, Novec FIFE-7300), 35 wt % of methyl ethyl ketone, 3.5 wt % of 1-hydroxycyclohexylphenylketone, and 0.5 wt % of a fluorine-based UV-curable-functional-group-containing compound (Shin-Etsu Chemical, KY-1203, solid content: 20%) using a stirrer, followed by filtration using a filter made of a PP material.

### Preparation Example 11

A hard coating composition was prepared by mixing 23 wt % of 6-functional urethane aciylate (Shin-Nakamura Chemical, U-6LPA), 23 wt % of 14-functional acrylate (Miwon Specialty Chemical, Miramer SP1106), 15 wt % of a fluorine-based solvent (3M, Novec FIFE-7500), 35 wt % of methyl ethyl ketone, 3.5 wt % of 1-hydroxycyclohexylphenylketone, and 0.5 wt % of a fluorine-based UV-curable-functional-group-containing compound (Fluoro Technology, FS-7026) using a stirrer, followed by filtration using a filter made of a PP material.

### Preparation Example 12

A hard coating composition was prepared by mixing 23 wt % of 6-functional urethane aciylate (Shin-Nakamura Chemical, U-6LPA), 23 wt % of 14-functional acrylate (Miwon Specialty Chemical, Miramer SP1106), 15 wt % of a fluorine-based solvent (3M, FC-3283), 35 wt % of methyl ethyl ketone, 3.5 wt % of 1-hydroxycyclohexylphenylketone, and 0.5 wt % of a fluorine-based UV-curable-functional-group-containing compound (Fluoro Technology, FS-7026) using a stirrer, followed by filtration using a filter made of a PP material.

### Preparation Example 13

A hard coating composition was prepared by mixing 23 wt % of 6-functional urethane acrylate (Shin-Nakamura Chemical, U-6LPA), 23 wt % of 14-functional acrylate (Miwon Specialty Chemical, Miramer SP1106), 40 wt % of a fluorine-based solvent (3M, Novec FIFE-7500), 10 wt % of methyl ethyl ketone, 3.5 wt % of 1-hydroxycyclohexylphenylketone, and 0.5 wt % of a fluorine-based UV-curable-functional-group-containing compound (Shin-Etsu Chemical, KY-1203, solid content: 20%) using a stirrer, followed by filtration using a filter made of a PP material.

### Preparation Example 14

A hard coating composition was prepared by mixing 23 wt % of 6-functional urethane acrylate (Shin-Nakamura Chemical, U-6LPA), 23 wt % of 14-functional acrylate (Miwon Specialty Chemical, Miramer SP1106), 50 wt % of methyl ethyl ketone, 3.5 wt % of 1-hydroxycyclohexylphenylketone, and 0.5 wt % of a fluorine-based UV-curable-functional-group-containing compound (Fluoro Technology, FS-7026) using a stirrer, followed by filtration using a filter made of a PP material.

### Preparation Example 15

A hard coating composition was prepared by mixing 20 wt % of a fluorine-based solvent (Nika, C6FOH-BF), 79.5 wt % of methyl ethyl ketone, and 0.5 wt % of a fluorine-based UV-curable-functional-group-containing compound (Shin-Etsu Chemical, KY-1203, solid content: 20%) using a stirrer, followed by filtration using a filter made of a PP material.

### Preparation Example 16

An antifouling hard coating composition was prepared by mixing 23 wt % of 6-functional urethane acrylate (Shin-Nakamura Chemical, U-6LPA), 23 wt % of 14-functional acrylate (Miwon Specialty Chemical, Miramer SP1106), 10 wt % of a fluorine-based solvent (Nika, C6FOH-BF), 40 wt % of methyl ethyl ketone, 3.5 wt % of 1-hydroxycyclohexylphenylketone, and 0.5 wt % of a silicone-based leveling agent (BYK, BYK-333) using a stirrer, followed by filtration using a filter made of a PP material.

### EXAMPLES AND COMPARATIVE EXAMPLES

### Example 1

The hard coating composition prepared in Preparation Example 1 was applied on a polyester film (PET, 50 μm) such that the thickness thereof after curing was 5 μm, after which the solvent was dried at 80° C. for 2 min, followed by irradiation with UV light in a cumulative dose of 600 mJ/cm² in a nitrogen atmosphere, thereby manufacturing a hard coating film.

### Example 2

The hard coating composition prepared in Preparation Example 2 was applied on a polyester film (PET, 50 μm) such that the thickness thereof after curing was 5 μm, after which the solvent was dried at 80° C. for 2 min, followed by irradiation with UV light in a cumulative dose of 600 mJ/cm² in a nitrogen atmosphere, thereby manufacturing a hard coating film.

### Example 3

The hard coating composition prepared in Preparation Example 3 was applied on a polyester film (PET, 50 μm) such that the thickness thereof after curing was 5 μm, after which the solvent was dried at 80° C. for 2 min, followed by irradiation with UV light in a cumulative dose of 600 mJ/cm² in a nitrogen atmosphere, thereby manufacturing a hard coating film.

### Example 4

The hard coating composition prepared in Preparation Example 4 was applied on a polyester film (PET, 50 μm) such that the thickness thereof after curing was 5 μm, after which the solvent was dried at 80° C. for 2 min, followed by irradiation with UV light in a cumulative dose of 600 mJ/cm² in a nitrogen atmosphere, thereby manufacturing a hard coating film.

### Example 5

The hard coating composition prepared in Preparation Example 5 was applied on a polyester film (PET, 50 μm) such that the thickness thereof after curing was 5 μm, after which the solvent was dried at 80° C. for 2 min, followed by irradiation with UV light in a cumulative dose of 600 mJ/cm² in a nitrogen atmosphere, thereby manufacturing a hard coating film.

### Example 6

The hard coating composition prepared in Preparation Example 6 was applied on a polyester film (PET, 50 μm) such that the thickness thereof after curing was 5 μm, after which the solvent was dried at 80° C. for 2 min, followed by irradiation with UV light in a cumulative dose of 600 mJ/cm² in a nitrogen atmosphere, thereby manufacturing a hard coating film.

### Example 7

The hard coating composition prepared in Preparation Example 7 was applied on a polyester film (PET, 50 μm) such that the thickness thereof after curing was 5 μm, after which the solvent was dried at 80° C. for 2 min, followed by irradiation with UV light in a cumulative dose of 600 mJ/cm² in a nitrogen atmosphere, thereby manufacturing a hard coating film.

### Example 8

The hard coating composition prepared in Preparation Example 8 was applied on a polyester film (PET, 50 μm) such that the thickness thereof after curing was 5 μm, after which the solvent was dried at 80° C. for 2 min, followed by irradiation with UV light in a cumulative dose of 600 mJ/cm² in a nitrogen atmosphere, thereby manufacturing a hard coating film.

### Example 9

The hard coating composition prepared in Preparation Example 9 was applied on a polyester film (PET, 50 μm) such that the thickness thereof after curing was 5 μm, after which the solvent was dried at 80° C. for 2 min, followed by irradiation with UV light in a cumulative dose of 600 mJ/cm² in a nitrogen atmosphere, thereby manufacturing a hard coating film.

### Example 10

The hard coating composition prepared in Preparation Example 10 was applied on a polyester film (PET, 50 μm) such that the thickness thereof after curing was 5 μm, after which the solvent was dried at 80° C. for 2 min, followed by irradiation with UV light in a cumulative dose of 600 mJ/cm² in a nitrogen atmosphere, thereby manufacturing a hard coating film.

### Example 11

The hard coating composition prepared in Preparation Example 11 was applied on a polyester film (PET, 50 μm) such that the thickness thereof after curing was 5 μm, after which the solvent was dried at 80° C. for 2 min, followed by irradiation with UV light in a cumulative dose of 600 mJ/cm² in a nitrogen atmosphere, thereby manufacturing a hard coating film.

### Example 12

The hard coating composition prepared in Preparation Example 12 was applied on a polyester film (PET, 50 μm) such that the thickness thereof after curing was 5 μm, after which the solvent was dried at 80° C. for 2 min, followed by irradiation with UV light in a cumulative dose of 600 mJ/cm² in a nitrogen atmosphere, thereby manufacturing a hard coating film.

### Example 13

The hard coating composition prepared in Preparation Example 13 was applied on a polyester film (PET, 50 μm) such that the thickness thereof after curing was 5 μm, after which the solvent was dried at 80° C. for 2 min, followed by irradiation with UV light in a cumulative dose of 600 mJ/cm² in a nitrogen atmosphere, thereby manufacturing a hard coating film.

### Comparative Example 1

The hard coating composition prepared in Preparation Example 14 was applied on a polyester film (PET, 50 μm) such that the thickness thereof after curing was 5 μm, after which the solvent was dried at 80° C. for 2 min, followed by irradiation with UV light in a cumulative dose of 600 mJ/cm² in a nitrogen atmosphere, thereby manufacturing a hard coating film.

### Comparative Example 2

The hard coating composition prepared in Preparation Example 15 was applied on a polyester film (PET, 50 μm) such that the thickness thereof after curing was 5 μm, after which the solvent was dried at 80° C. for 2 min, followed by irradiation with UV light in a cumulative dose of 600 mJ/cm² in a nitrogen atmosphere, thereby manufacturing a hard coating film.

### Comparative Example 3

The hard coating composition prepared in Preparation Example 16 was applied on a polyester film (PET, 50 μm) such that the thickness thereof after curing was 5 μm, after which the solvent was dried at 80° C. for 2 min, followed by irradiation with UV light in a cumulative dose of 600 mJ/cm² in a nitrogen atmosphere, thereby manufacturing a hard coating film.

### TEST EXAMPLES

(1) Antifouling Performance

A water contact angle was measured using a contact angle meter DSA100 made by KRUSS in the state in which the hard coating layer was oriented upwards. The volume of the liquid droplet at room temperature was 3 jig, and the results thereof are shown in Table 1 below.

(2) Wear Resistance

Wear resistance was measured using a wear resistance meter made by Daesung Precision Machine in the state in which the hard coating layer was oriented upwards. Specifically, the surface of the hard coating layer was rubbed 3000 times using an eraser for wear resistance testing under a load of 1 kg, after which the contact angle was measured. The volume of the liquid droplet at room temperature was 3 μl, and the results thereof are shown in Table 1 below.

(3) Pencil Hardness

A substrate film was fixed to glass such that the surface of the hard coating layer was oriented upwards, after which pencil hardness was measured under a load of 1 kg. The test was performed five times to a length of 1 cm using a pencil of given hardness, and the pencil hardness at which a maximum of 4 scratches were formed was determined to be the final pencil hardness of the film, and the results thereof are shown in Table 1 below.

(4) Scratch Resistance

A substrate film was attached to glass using a transparent pressure-sensitive adhesive such that the surface of the hard coating layer was oriented upwards, after which scratch resistance was measured through reciprocating friction 10 times using steel wool (#0000) with a load of 500 g/cm² applied thereto. The evaluation criteria were as follows.

◯: When the measurement portion is observed through transmission and reflection using a triple-wavelength lamp, scratches are invisible, or 10 or fewer scratches are visible.

×: When the measurement portion is observed through transmission and reflection using a triple-wavelength lamp, more than 10 scratches are visible.

(5) Adhesion

A substrate film was attached to glass using a transparent pressure-sensitive adhesive such that the surface of the hard coating layer was oriented upwards, after which a grid of 100 squares was formed at intervals of 1 mm on the surface of the hard coating layer using a cutter knife, and an adhesion (peel) test was performed three times using a tape (CT-24, made by Nichiban, Japan). Three sets of 100 squares were tested, and the average value thereof was recorded.

Adhesion=n/100

n: Number of squares that did not peel out of all squares

100: Total number of squares

TABLE 1

| | Antifouling | Wear | Pencil | Scratch | |
|---|---|---|---|---|---|
| | performance | resistance | hardness | resistance | Adhesion |
| Example 1 | 111° | 101° | 3H | ∘ | 100/100 |
| Example 2 | 112° | 102° | 3H | ∘ | 100/100 |
| Example 3 | 111° | 101° | 3H | ∘ | 100/100 |
| Example 4 | 112° | 103° | 3H | ∘ | 100/100 |
| Example 5 | 113° | 104° | 3H | ∘ | 100/100 |
| Example 6 | 111° | 103° | 3H | ∘ | 100/100 |
| Example 7 | 112° | 102° | 3H | ∘ | 100/100 |
| Example 8 | 113° | 102° | 3H | ∘ | 100/100 |
| Example 9 | 113° | 103° | 3H | ∘ | 100/100 |
| Example 10 | 113° | 105° | 3H | ∘ | 100/100 |
| Example 11 | 112° | 101° | 3H | ∘ | 100/100 |
| Example 12 | 112° | 104° | 3H | ∘ | 100/100 |
| Example 13 | 114° | 105° | 3H | ∘ | 100/100 |
| Comparative | 110° | 95° | 3H | ∘ | 100/100 |
| Example 1 | | | | | |
| Comparative | 112° | 58° | 6B | x | 100/100 |
| Example 2 | | | | | |
| Comparative | 85° | 43° | 3H | ∘ | 100/100 |
| Example 3 | | | | | |

As is apparent from Table 1, the hard coating film according to the present invention was superior in all of antifouling performance, wear resistance, pencil hardness, scratch resistance and adhesion.

What is claimed is:

1. A hard coating film, comprising:
a substrate; and
a hard coating layer provided on at least one surface of the substrate,
wherein the hard coating layer comprises a cured product of a hard coating composition containing a fluorine-based UV-curable-functional-group-containing compound, a light-transmissive resin, and a fluorine-based solvent, and
the fluorine-based solvent is contained in an amount of 0.1 to 40 wt % based on a total of 100 wt % of the hard coating composition.

2. The hard coating film of claim 1, wherein the fluorine-based UV-curable-functional-group-containing compound is contained in an amount of 0.01 to 30 wt % based on a total of 100 wt % of a solid content of the hard coating composition.

3. The hard coating film of claim 1, wherein the fluorine-based solvent is contained in an amount of 0.1 to 30 wt % based on a total of 100 wt % of the hard coating composition.

4. The hard coating film of claim 1, wherein the fluorine-based UV-curable-functional-group-containing compound comprises at least one selected from the group consisting of a perfluoro-alkyl-group-containing (meth)acrylate, a perfluoro-polyether-group-containing (meth)acrylate, a perfluoro-cycloaliphatic-group-containing (meth)acrylate, and a perfluoro-aromatic-group-containing (meth)acrylate.

5. The hard coating film of claim 1, wherein the fluorine-based solvent comprises at least one selected from the group consisting of perfluorohexylethyl alcohol, perfluoroether, and perfluorohexane.

6. The hard coating film of claim 1, wherein the hard coating composition further comprises at least one selected from the group consisting of a photoinitiator, an additional solvent, and an additive.

7. The hard coating film of claim 1, wherein the hard coating layer has a water contact angle of 100° or more.

8. The hard coating film of claim 1, wherein the hard coating layer has a contact angle of 100° or more after being rubbed 3000 times using an eraser under a load of 1 kg.

9. A window comprising the hard coating film of any one of claims 1 to 8.

10. An image display device comprising the window of claim 9 and a display panel, and further comprising a touch sensor and a polarizing plate between the window and the display panel.
